(19) United States
(12) Patent Application Publication
(10) Pub. No.: US 2006/0049803 A1
(43) Pub. Date: Mar. 9, 2006

(54) Critical-voltage indicator for a vehicle battery

(76) Inventors: Hamid Sahebjami, Cincinnati, OH (US); Steve Sahebjam, Columbia, MD (US)

Correspondence Address: BANNER & WITCOFF, LTD., TEN SOUTH WACKER DRIVE, SUITE 3000, CHICAGO, IL, 60606, US

(21) Appl. No.: 11/215,062

(22) Filed: Aug. 30, 2005

Related U.S. Application Data
(60) Provisional application No. 60/608,253, filed on Sep. 9, 2004.

(51) Int. Cl. H02J 7/00

(52) U.S. Cl. 320/134

(57) ABSTRACT

The present invention provides methods and apparatuses for the detection and warning of a critical voltage of a vehicle battery. An apparatus includes a voltage regulator, a voltage-level detector, a logic circuit, and a light-emitting diode (LED) with a current-protection circuit for providing an indication when the battery voltage drops below a critical voltage level.

This application claims priority to provisional U.S. Application Ser. No. 60/608,253 (“Critical-Voltage Indicator for Automobiles”), filed Sep. 9, 2004.

### FIELD OF THE INVENTION

The invention relates to apparatuses that determine whether a voltage of a vehicle battery is below a threshold when the vehicle ignition is activated.

### BACKGROUND OF THE INVENTION

The voltage level at the terminals of a vehicle battery typically ranges from 12 to 14 Vdc if the battery is fairly new (within the first three years of purchase). During the useful life of a battery, any loss of electrical charge (corresponding to battery voltage) is replenished by the vehicle's alternator/charger system. However, with time, due to corrosion and mineral accumulation in the battery, individual cells within the battery lose their ability to retain sufficient charge to start the engine when the ignition is activated.

One typically becomes aware of a dead or a rapidly dying battery/charger by a fading sound when cranking the engine, a total silence of the starter following the activation of the ignition key, or the sudden stoppage of the engine after a quick braking of the vehicle. Needless to say, these symptoms are too late to prevent an unexpected, inconvenient, and possibly a potentially dangerous situation for the driver and passengers of the vehicle.

The prior art provides battery-charge indicators and battery voltage-level detectors. However, there is a real need for alarm apparatus to warn an operator of a vehicle about the condition of the battery/charger.

### SUMMARY OF THE INVENTION

The present invention provides methods and apparatuses for the detection and warning of a critical voltage of a vehicle battery. In an embodiment of the invention, an apparatus includes a voltage regulator, a voltage-level detector, a logic circuit, and a light-emitting diode (LED) with a current-protection circuit for providing a visual warning light when the battery voltage drops below a critical voltage level. In an embodiment of the invention, complimentary metal oxide semiconductor (CMOS) technology is incorporated, providing a wide operating range for the supply voltage, low-quiescent current, and low-power consumption.

Other features and advantages of the invention will become apparent to those skilled in the art upon review of the following detailed description, claims and drawings in which like numerals are used to designate like features.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 is a circuit diagram of an apparatus in accordance with an embodiment of the invention; and

FIG. 2 shows an implementation of an apparatus in accordance with an embodiment of the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

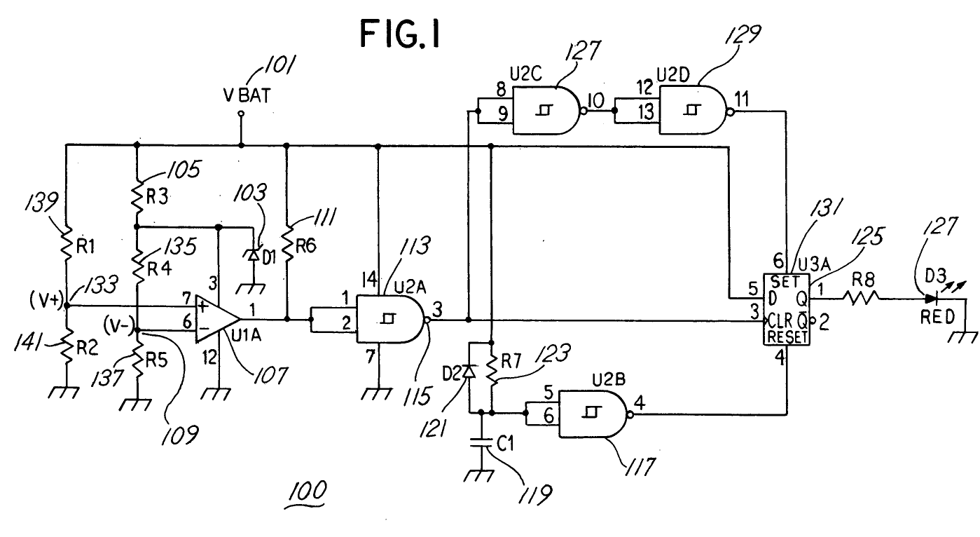

FIG. 1 shows circuit diagram 100 of an apparatus in accordance with an embodiment of the invention. For a very distinct and pre-selected range of battery voltages (corresponding to V_{bat} 101), zener diode 103 (D1) and resistor 105 (R3) perform two functions:
provide a regulated supply voltage to comparator 107 (U1A) and
establish a reference voltage at its inverting terminal 109.

Resistor 111 (R6) and NAND gate 113 (U2A) ensure that under all normal conditions U2A output 115 (pin 3) is always at a low logic level.

The voltage level at inverting terminal 109 is typically held at a voltage level approximately equal to the critical voltage of the battery as determined by resistors 135 and 137. Also, a voltage level at non-inverting input 133 of comparator 107 is set by resistors 139 and 141. With a good battery that is well charged, the voltage at non-inverting input 133 is greater than the voltage at inverting input 109. Whenever, the battery voltage drops below the critical value, the output voltage of comparator 107 drops to approximately zero volts. The drop of the output voltage initiates a warning signal, as will be discussed.

CMOS gate 117 U2B and its associated components (C1 119, D2 121, and R7 123) perform a power-up reset function to remove any ambiguities at U3A output 125 (pin 1), whenever power is applied (e.g., when the ignition is activated).

NAND gates 127 and 129 (U2C and U2D, respectively) also insure that, under normal battery operation, the voltage of U3A output 125 is kept a low logic level. Should a low battery voltage exist, apparatus 100 causes U3A output 125 to change to a high logic level, typically within 3 msec. Consequently red light emitting diode (LED) 127 activates and emits light.

When the ignition key (not shown) is activated and if the battery voltage V_{bat} 101 drops to a specific level, comparator 107 (U1A) trips, causing the output of gate 113 to transition from a low logic level (Lo) to a high logic level (Hi). The resulting rising-edge, voltage-step clocks flip flop 131 (U3A) into a set mode (corresponding to output 125 being at a high logic level) and causes LED 127 to light. LED 127 remains on until either the power is removed (ignition is deactivated) or the battery voltage is restored.

On the other hand, if a low voltage condition existed while the vehicle was not in use, once any attempt is made to start the engine, the LED will light (typically after 3 msec) and will remain on.

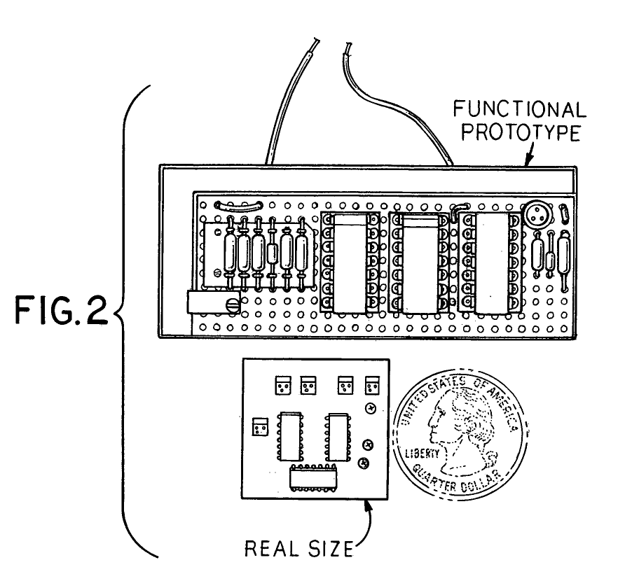

FIG. 2 shows an implementation of an apparatus in accordance with an embodiment of the invention. Both a functional prototype (corresponding to “Functional Prototype”) and a post-prototype implementation (corresponding to “Real Size”) of apparatus 100 are shown. Other embodiments of the invention may be implemented with an application specific integrated circuit chip (ASIC) or with a processor that interfaces with an analog to digital converter.

Embodiments of the invention provide a voltage indication for a battery system for a vehicle (e.g., as an automobile, motorcycle, or truck) that is propelled by an internal combustion engine, e.g., spark ignition engine or Diesel engine. Other embodiments of the invention support a vehicle that is propelled by an electric motor or by a hybrid motor configuration (e.g., comprising an electric motor and a gasoline engine).

It should be understood that the invention is not limited in its application to the details of construction and arrangements of the components set forth herein. The invention is capable of other embodiments and of being practiced or carried out in various ways. Variations and modifications of the foregoing are within the scope of the present invention. It is also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. An apparatus that detects a low voltage condition for a battery of a vehicle, the apparatus comprising:
a voltage regulator that provides a voltage reference having a corresponding predetermined voltage value;
a voltage detector that compares a voltage representation of the battery and the voltage reference and that provides a corresponding detection output; and
a logic circuit that captures the corresponding detection output to form a captured detection output.

2. The apparatus of claim 1, further comprising:
an indicator that electrically couples to the logic circuit and that provides an indication associated with the captured detection output.

3. The apparatus of claim 1, wherein the voltage detector compares the voltage representation of the battery when the battery is energizing a starter motor.

4. The apparatus of claim 1, wherein the voltage detector compares the voltage representation of the battery when an engine of the vehicle is inactive.

5. The apparatus of claim 1, wherein the voltage detector compares the voltage representation of the battery when an engine of the vehicle is active.

6. The apparatus of claim 1, wherein the logic circuit includes a register that is configured in response to receiving the corresponding detection output.

7. The apparatus of claim 6, wherein the register includes a flip flop circuit.

8. The apparatus of claim 2, wherein the indicator includes a visual display.

9. The apparatus of claim 1, wherein the logic circuit includes an initialization circuit that initializes the apparatus to an initial state when the apparatus is activated.

10. The apparatus of claim 1, wherein the apparatus comprises an application specific integrated circuit (ASIC).

11. The apparatus of claim 1, further comprising:
an analog to digital converter that transforms the voltage representation to a digital format.

12. The apparatus of claim 8, wherein the visual display includes a light emitting diode (LED).

13. An apparatus that detects a low voltage condition for a battery of a vehicle, the apparatus comprising:
an interface that obtains a voltage representation of the battery;
a voltage regulator that provides a voltage reference having a corresponding predetermined voltage value;
a processor that is configured to perform:
(a) comparing the voltage reference with the voltage representation to provide a comparison result; and
(b) capturing the comparison result to form a captured result;

14. The apparatus of claim 13, wherein the processor is configured to further perform:
(c) conveying the captured result to an indicator.

15. The apparatus of claim 13, wherein the processor is configured to further perform:
(b)(i) comparing the voltage reference with the voltage representation when the battery is energizing a starter motor.

16. The apparatus of claim 13, wherein the processor is configured to further perform:
(b)(i) comparing the voltage reference with the voltage representation when an engine of the vehicle is inactive.

17. The apparatus if claim 13, wherein the processor is configured to further perform:
(b)(i) comparing the voltage reference with the voltage representation when an engine of the vehicle is active.

18. The apparatus of claim 13, wherein the interface includes an analog to digital converter that transforms the voltage representation into a digital format.

19. The apparatus of claim 13, wherein the processor is configured to further perform:
(c) initializing the apparatus when the apparatus is activated.

20. The method for indicating a low voltage condition for a battery of a vehicle, the apparatus comprising:
(a) generating a voltage reference having a corresponding predetermined voltage value;
(b) obtaining a voltage representation of the battery;
(c) comparing, when the battery is energizing a starter motor of the vehicle, the voltage reference with the voltage representation of the battery to obtain a corresponding detection output;
(d) capturing the corresponding detection output to form a captured detection output; and
(e) configuring a display according to the captured detection output.
